(19) United States
(12) Patent Application Publication
(10) Pub. No.: US 2026/0048597 A1
(43) Pub. Date: Feb. 19, 2026

(54) Linerless Thermal Printer

(71) Applicant: GeBE Elektronik und Feinwerktechnik GmbH, Germering (DE)

(72) Inventor: Klaus Baldig, Germering (DE)

(21) Appl. No.: 19/298,154

(22) Filed: Aug. 12, 2025

(30) Foreign Application Priority Data
Aug. 14, 2024 (EP) 24194679.7

(51) Int. Cl. B41J 11/00; B41J 3/407; B41J 11/04; B41J 11/14; B41J 11/70; B41J 13/00

(52) U.S. Cl. CPC B41J 11/0095; B41J 3/4075; B41J 11/04; B41J 11/14; B41J 11/70; B41J 13/0027

(57) ABSTRACT

A method for operating a linerless thermal printer involves moving a front edge of a linerless printing material in a reverse direction counter to a conveying direction from a waiting position (II) towards a print start position (I) before printing on the linerless printing material. The waiting position of the front edge is disposed on an opposite side of a cutter from a platen roller of the linerless thermal printer. Printing on the linerless printing material is performed after the moving of the front edge of the linerless printing material in the reverse direction. The printing on the linerless printing material begins with the front edge of the linerless printing material being disposed at the print start position. In one embodiment, the print start position of the front edge of the linerless printing material is disposed at the platen roller.

### CROSS REFERENCE TO RELATED APPLICATION

This application is based on and hereby claims the benefit under 35 U.S.C. § 119 from European Patent Application No. EP 24194679.7, filed on Aug. 14, 2024, in the European Patent Office. This application is a continuation-in-part of European Patent Application No. EP 24194679.7, the contents of which are incorporated herein by reference.

### TECHNICAL FIELD

The invention relates to a method for operating a linerless thermal printer. Furthermore, the invention relates to a computer program product, to a linerless thermal printer and to a control unit for such a linerless thermal printer.

### BACKGROUND

A printer is a device configured to read text and/or graphics in machine-readable form and transfer the text or graphics to a printing material in order to provide a printed product. A printing material is understood to be a print material that can be printed on in a printing process carried out by the printer, while the end result is referred to as a printed product.

Thermal printing is a printing process that uses the selective application of heat to the printing material. Common applications include cash register printers, travel ticket printers or parking ticket printers. In this case, the printer is configured as a label printer that can print labels from rolls or fanfolds continuously. For example, such a thermal printer can be configured as a ticket printer or a label printer.

The printed product can be a linerless printed product formed by printing on a linerless printing material. A linerless printing material is understood to be a backing-free, endless printing material rolled into a roll that can be printed on one side using a thermal printing process. Such a linerless printing material is provided with an adhesive coating on its back, while a release coating is provided on its front, which comes into contact with the adhesive-coated back when rolled into a roll and prevents unwanted sticking of the linerless printing material when rolled into a roll.

In operation, after the linerless printed product has been completed by printing on the linerless printing material, the linerless printed product is separated from the remaining linerless printing material by cutting it off. The remaining linerless printing material remains between the print head and the platen roller. In some cases, the remaining linerless printing material is retracted into a print start position after cutting. If the remaining linerless printing material remains in this print start position for too long, the remaining linerless printing material may stick to the platen roller.

In particular, after the printer has been inactive for a long time, the adhesive coating sticks to the platen roller due to the pressure against the print head. The resulting adhesive force between the linerless printing material and the platen roller may depend on the contact pressure, the adhesive strength of the adhesive coating, the aging of an anti-sticking coating on the platen roller and the contact time. Consequently, when a new printing operation is initiated, the remaining linerless printing material may stick to and subsequently wrap around the platen roller.

In order to release the adhesive bond, EP2143561A2 describes moving the remaining linerless printing material according to a movement pattern in the transport direction and counter to the transport direction of the linerless printing material during a printing operation. However, such an adhesive bond cannot be reliably released especially if the linerless thermal printer has been inactive for a long time.

There is therefore a need to identify ways to improve the operation of such a linerless thermal printer, especially if the linerless thermal printer has been inactive for a long time. The object of the invention is solved by a method for operating a linerless thermal printer, the method at least comprising the step of:
moving a linerless printing material in reverse direction counter to a conveying direction from a waiting position to a print start position before printing on the linerless printing material.

### SUMMARY

The invention relates to a method for operating a linerless thermal printer, the method at least comprising the step of: moving a linerless printing material in reverse direction counter to a conveying direction from a waiting position (II) to a print start position (I) before printing on the linerless printing material.

A method for operating a linerless thermal printer involves moving a front edge of a linerless printing material in a reverse direction counter to a conveying direction from a waiting position (II) towards a print start position (I) before printing on the linerless printing material. The waiting position of the front edge is disposed on an opposite side of a cutter from a platen roller of the linerless thermal printer. Printing on the linerless printing material is performed after the moving of the front edge of the linerless printing material in the reverse direction. The printing on the linerless printing material begins with the front edge of the linerless printing material being disposed at the print start position. In one embodiment, the print start position of the front edge of the linerless printing material is disposed at the platen roller.

The method also involves reading in a measurement signal from a sensor of the linerless thermal printer. The measurement signal indicates whether the front edge of the linerless printing material has reached the position of the sensor. The method involves generating a reverse control signal for controlling a motor of the linerless thermal printer that drives the platen roller so as to move the linerless printing material in the reverse direction until the sensor detects the front edge of the linerless printing material. The method involves generating the reverse control signal for controlling the motor of the linerless thermal printer that drives the platen roller so as to move the linerless printing material in the reverse direction by a predetermined feed length after the sensor has detected the front edge of the linerless printing material.

A novel linerless thermal printer includes a print head, a platen roller, a cutter, a sensor, a motor and a controller. The motor drives the platen roller. The linerless thermal printer is configured to move a front edge of a linerless printing material in a reverse direction counter to a conveying direction from a waiting position to a print start position. The waiting position of the front edge of a linerless printing material is disposed on an opposite side of the cutter from the platen roller. The linerless thermal printer moves the front edge of the linerless printing material in the reverse direction prior to printing on the linerless printing material. The controller is configured to monitor a measurement signal output by the sensor. The measurement signal indicates that the front edge of the linerless printing material has reached the position of the sensor. The controller is configured to generate a reverse control signal for controlling the motor so as to move the linerless printing material in the reverse direction until the sensor detects the front edge of the linerless printing material. The controller is configured to generate the reverse control signal for controlling the motor so as to move the linerless printing material in the reverse direction by a predetermined feed length.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 schematically shows a linerless thermal printer in a first operating state.

FIG. 2 schematically shows the linerless thermal printer shown in FIG. 1 in another operating state, depicting the front end of the linerless printing material in the print start position I.

FIG. 3 schematically shows the linerless thermal printer shown in FIG. 1 in another operating state, depicting the linerless printed product wound around the platen roller due to unwanted adhesion thereto.

FIG. 4 schematically shows the linerless thermal printer shown in FIG. 1 in another operating state, depicting a paper jam between the cutting device and the platen roller due to unwanted adhesion of the linerless printed product to the platen roller.

FIG. 5 schematically shows the linerless thermal printer shown in FIG. 1 in another operating state, depicting the feed length.

FIG. 6 schematically shows the linerless thermal printer shown in FIG. 1 in another operating state depicting the feed length W2.

FIG. 7 schematically shows a method sequence for operating the thermal printer shown in FIGS. 1-6.

### DETAILED DESCRIPTION

Reference will now be made in detail to some embodiments of the invention, examples of which are illustrated in the accompanying drawings.

The print start position is defined in that a front end of the linerless printing material in the conveying direction is located between the print head and the platen roller. The print start position can be located in the conveying direction in the region between the print head and the platen roller of the linerless thermal printer on one side and the cutting device of the linerless thermal printer on the other side.

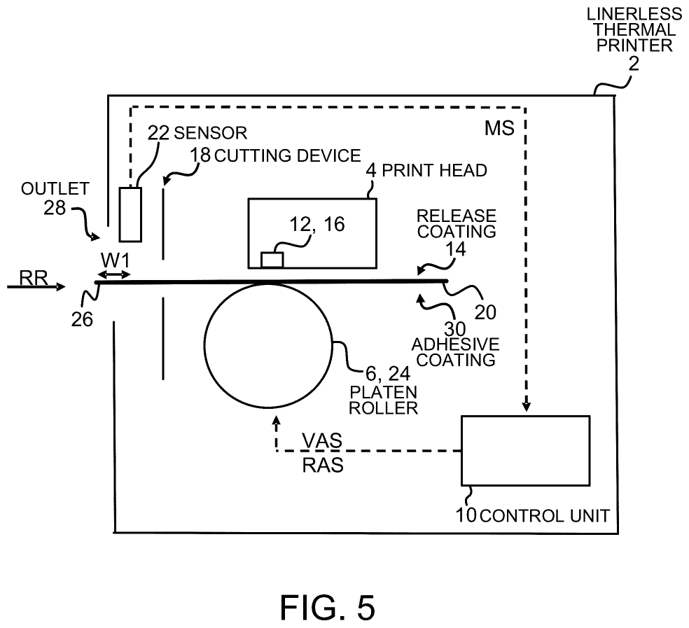

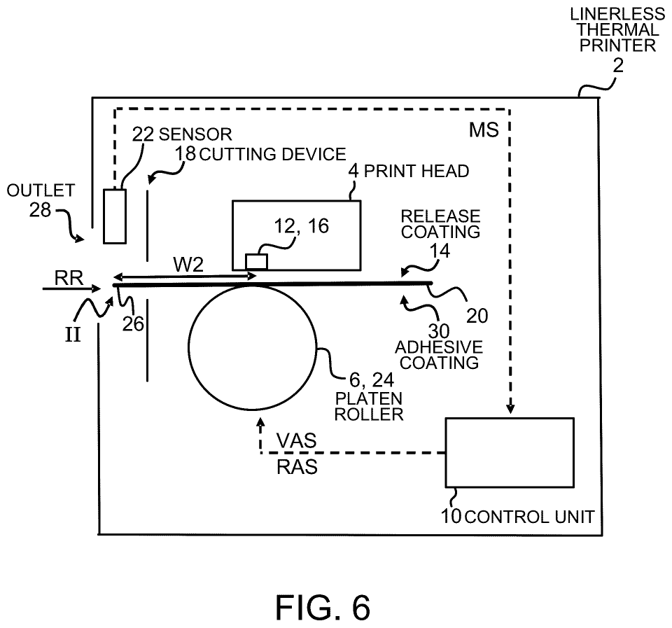

The waiting position is the position in which the front end of the linerless printing material is positioned (“parked”) when the thermal printer undergoes a phase of inactivity. The waiting position is defined in such a way that unprinted linerless printing material, in particular the front end of the linerless printing material, is located in the region in front of the print head and the platen roller or behind the print head and the platen roller. Preferably, the waiting position is located behind the print head and the platen roller in the conveying direction. The waiting position can be located behind the cutting device of the linerless thermal printer in the conveying direction (see, e.g., FIGS. 5-6). Alternatively, the waiting position can be located in front of the cutting device of the linerless thermal printer in the conveying direction, so that the waiting position is between the cutting device on one side and the print head and platen roller on the other side. In case the thermal printer comprises a sensor (as described in detail below), the waiting position may be located at the sensor or preferably beyond the sensor (in conveying direction). In a particular preferred embodiment, the printer components are positioned in the following order in the conveying direction: print head/platen roller-cutter-sensor-waiting position.

The print start position and the waiting position are arranged such that, after being moved in the reverse direction by a reverse control signal, the front end of the linerless printing material is located in the print start position between the print head and the platen roller. In other words, the feed length by which the linerless printing material is moved corresponds at least to the distance between the print start position and the waiting position. Accordingly, the section of the linerless printing material that is moved has a length in the conveying direction that corresponds to this predetermined feed length.

In other words, a new printing order starts with the linerless printing material being drawn in by moving it in the reverse direction for a certain feed length before printing. The print head is inactive at this time, meaning that the linerless printing material is not printed on. Surprisingly, it has been found that in this way the linerless printing material and its adhesive coating, respectively, can be released from the platen roller reliably and with little effort. What is more, even if the linerless printing material remains at the waiting position for an extended length of time, e.g., in case of large pauses between printing jobs or in case the printer is turned off, any attachment of the linerless printing material to the platen roller can be released by merely moving the linerless material backwards to the print start position.

Thus, there is no need for repeated back and forward transport of the linerless printing material after the linerless thermal printer has been inactive.

According to one embodiment, the method further comprises the steps of:
reading in a measurement signal from a sensor of the linerless thermal printer, wherein the measurement signal indicates that a front end of the linerless printing material in the conveying direction has reached a position of the sensor, and
providing a reverse control signal for controlling a motor of the linerless thermal printer driving a platen roller so as to move the linerless printing material in the reverse direction until the sensor has detected the front end of the linerless printing material, and
providing the reverse control signal for controlling the motor of the linerless thermal printer driving the platen roller so as to move the linerless printing material in the reverse direction by a predetermined feed length if the sensor has detected the front end of the linerless printing material.

The front end of the linerless printing material is a section that has been separated from a completed linerless printed product by a cutting device of the linerless thermal printer.

In a first sub-step, a sensor, such as an optical sensor, such as a light barrier, is used to detect whether the front end of the linerless printing material has reached the position of the sensor and thus brings about a signal change, e.g., from logical zero to logical one.

In a second sub-step, starting from this detected position, the linerless printing material is then moved in the reverse direction by a predetermined feed length. The predetermined feed length corresponds essentially, i.e., within usual technical limits, to a distance between the position of the sensor on one side and the print start position on the other side, defined by the position of the combination consisting of the print head and platen roller.

Alternatively, during the first sub-step, the linerless printing material is moved by a potentially indefinite distance, to the position of the sensor. In most cases the feed length will be identical to the feed length, which the linerless printer material was transported forward beyond the sensor before (as explained in more detail below). However, any difference in the position of the end of the linerless printing material from the default (see, e.g., FIG. 5), will be compensated for, since the linerless printing material will be transported up to the sensor anyway.

During the following, second sub-step, the linerless printing material is moved by the predetermined feed length, i.e., the distance between the waiting position and the print start position (e.g., the distance between the sensor and the print head/platen roller), to reach the print start position.

This allows exact positioning of the linerless printing material, in particular it ensures that linerless printing material is located between the print head and the platen roller at the start of a printing operation, ensuring smooth operation of the linerless thermal printer.

To allow for the moving of the linerless printing material in the reverse direction before printing, the front end of the linerless printing material is maintained in a waiting position during phases of printer inactivity. During a phase of printer inactivity, the front end of the printing material may be positioned beyond the sensor. In this case, at the end of a phase of inactivity, e.g., when a new printing order is started, the printer performs the first sub-step, and subsequently the second sub-step. Alternatively, the front end of the printing material may be positioned at the sensor during a phase of printer inactivity. In this case, the first sub-step was performed previously, and the printer starts with the second sub-step when a new printing order commences.

According to a further embodiment, the method comprises the further step of:
suppressing the reverse control signal for controlling a motor of the linerless thermal printer driving a platen roller so as to move the linerless printing material in the reverse direction, if the sensor has not detected the front end of the linerless printing material.

In other words, if the front end of the linerless printing material is not detected by the sensor, the movement in the reverse direction will not take place. For this, it is possible to wait for a predetermined time period, which is recorded by a timer. The subsequent printing operation then does not start at the front end of the linerless printing material, but in the reverse direction away from it. This ensures smooth operation of the linerless thermal printer even if no linerless printing material has been detected by the sensor. In particular, by suppressing the reverse transport in case the front end of the linerless material is not detected, or no linerless printing material is detected at all by the sensor, unintended drop off of the linerless material at the back of the platen roller due to inappropriate reverse transport can be avoided.

According to a further embodiment, the method comprises the further steps of:
upon detecting completion of a preceding printing operation, detecting expiration of a predetermined time period, and
after expiration of the predetermined time period has been detected, providing a forward control signal for controlling the motor of the linerless thermal printer driving the platen roller so as to move the linerless printing material in the conveying direction.

The completion of the preceding printing operation may be defined as the moment the printed product is cut off the linerless printing material (with the front end of the linerless printing material located at the cutter), or after the front end of the linerless printing material has been transported a short distance beyond the cutter following cutting (with the front end of the linerless printing material located beyond the cutter in the conveying direction). Likewise, the completion of the preceding printing operation may be defined as the moment the linerless printing material has been transported backwards to the print start position after the printed product has been cut off. The predetermined time period can be recorded using a timer or other timing device. The time period can be shorter than one second and up to multiple hours. Preferably, the time period is between 5 and 30 minutes, more preferred about 30 minutes. In case the printer is activated during timer duration, the timer restarts after the interruption. By providing a forward control signal the linerless printing material is moved so as to reach the waiting position. If thereupon a further printing operation is initiated after the preceding printing operation has been completed and the time period has expired, the front end of the linerless printing material is moved in the reverse direction to a print start position between the print head and the platen roller, as described above. In other words, the further printing operation following the preceding printing operation begins with a movement in the reverse direction before the actual printing operation begins with the print head activated and the linerless printing material is moved in the conveying direction.

In an alternative embodiment, no timer is used and the linerless paper material is transported in the conveying direction to reach the waiting position directly upon the completion of the preceding printing operation, e.g., after the printed product is cut off the linerless printing material.

In a further embodiment, the printer may be configured such that the linerless printing material is transported in the conveying direction to reach the waiting position if the printer is shut down. This ensures that the linerless printing material is positioned at the waiting position when the printer is switched on again. Accordingly, the first printing operation after switching on can start by reversing the linerless printing paper from the waiting position to the print start position, thereby releasing any adverse adhesion of the linerless printing material to the platen roller.

Taken together, the forward control signal moves the linerless printing material in the conveying direction. Therefore, the front end of the linerless printing material is located in the defined position, which also ensures smooth operation of the linerless thermal printer.

According to a further embodiment, the method comprises the further steps of:
detecting a manual trigger signal, and
upon detecting the manual trigger signal, providing a forward control signal for controlling the motor of the linerless thermal printer driving the platen roller so as to move the linerless printing material in the conveying direction.

For example, the linerless thermal printer can have an actuation button, by means of which, when pressed, a user can generate the trigger signal for moving the linerless printing material to the waiting position.

Instead of an actuation button, a touch button on a touch screen of the linerless thermal printer or a corresponding menu item in the operating menu of the linerless thermal printer can also be provided. Likewise, any command, in particular for moving the front end of the linerless printing material to the waiting position, may be provided by an external host. This allows the user deliberately to move the linerless printing material to the waiting position, e.g., before switching the printer off. Likewise, errors may be handled that way, in case the linerless printing material is not moved forward automatically, for example after changing the linerless printing material.

Furthermore, the invention relates to a computer program product, to a linerless thermal printer and to a control unit for such a linerless thermal printer.

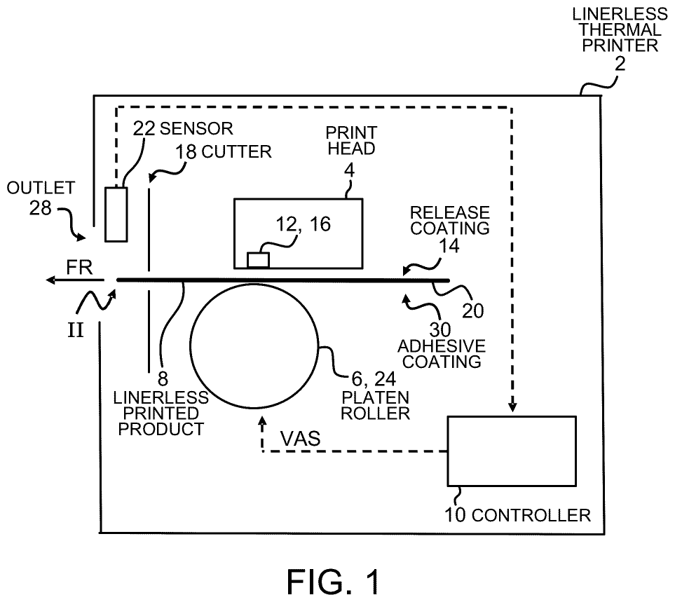

FIG. 1 shows the components of a linerless thermal printer 2.

The components are a print head 4, a platen roller 6, a controller 10 and a cutter 18, as well as a sensor 22. The print head 4 can be used to print on a linerless printing material 20 by means of thermal printing in order to provide a linerless printed product 8. For this, in the present exemplary embodiment, the print head 4 has a heating line 12 with a plurality of heating elements 16, each with a heating resistor, which are arranged in a row.

In the present exemplary embodiment, the printed product is a linerless printed product 8, which is provided by printing on linerless printing material 20. In the present exemplary embodiment, the linerless printing material 20 is provided with an adhesive coating 30 on its back, while a release coating 14 is provided on its front, which comes into contact with the back comprising the adhesive coating 30 when wound, for example, into a roll and prevents unwanted sticking of the linerless printing material 20 when rolled into a roll.

The platen roller 6 serves to transport the linerless printing material 20 and the linerless printed product 8, respectively, to an outlet 28 of the thermal printer 2 in the conveying direction FR.

In the present exemplary embodiment, the control unit 10 is configured to control at least one motor 24 of the platen roller 6 by means of a forward control signal VAS in such a way that the platen roller 6 moves the linerless printing material 20 and the linerless printed product 8, respectively, to the outlet 28 of the thermal printer 2 in the conveying direction FR and controls the heating line 12 with the plurality of heating elements 16 in such a way that the linerless printed product 8 is provided with the desired print. In one embodiment, the controller 10 comprises a microcontroller.

Furthermore, in the present exemplary embodiment, the control unit 10 is configured to control the cutter 18 such that after completion of the linerless printed product 8 by printing on the linerless printing material 20, the linerless printed product 8 is separated from the remaining linerless printing material 20. The remaining linerless printing material 20 remains between the print head 4 and the platen roller 6. In particular, the front end 26 of the linerless printing material 20 may be transported to the print start position I after the printed product was cut off.

The sensor 22 can detect that the linerless printing material 20 has reached a waiting position II (see FIG. 6). In particular, the sensor 22 can be configured to detect the presence of linerless printing material 20 per se as well as the front end 26 of the linerless printing material 20, e.g., during reverse transport. For example, the sensor 22 may be a photoelectric sensor, which is interrupted in the presence of linerless printing material 20, and recognizes the front end 26 of the linerless printing material 20 during reverse transport by the interruption being terminated. In addition, the control unit 10 can assess the respective state of the sensor 22, as will be explained in detail below.

The linerless thermal printer 2 and its aforementioned components, i.e., the print head 4, the platen roller 6 with the motor 24, the control unit 10 and the cutting device 18, as well as the sensor 22, can each have appropriately configured hardware and/or software components for these tasks and functions and those described below.

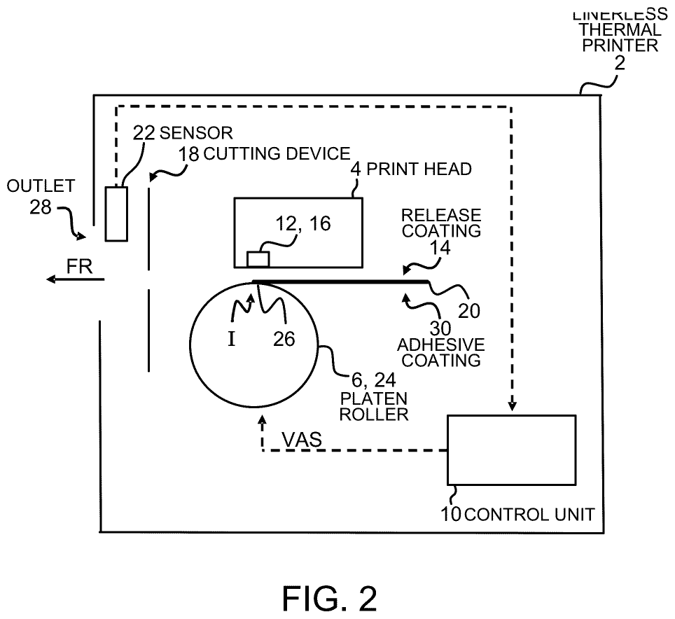

Additionally, reference is now made to FIG. 2. It is shown that after the completed linerless printed product 8 has been cut off from the linerless printing material 20, the remaining linerless printing material 20 is retracted counter to the conveying direction FR into a print start position I, in which a front end 26 of the linerless printing material 20 is located between the print head 4 and the platen roller 6. The print start position I can also be regarded as a start position since, at least in regular operation, a printing operation with the print head 4 activated, i.e., printing on linerless printing material 20, begins between the print head 4 and the platen roller 6.

Alternatively, the print start position I can be located in the conveying direction FR in the region between the print head 4 and the platen roller 6, for example where the print head 4 contacts the platen roller 6, on one side and the cutting device 18 on the other side. If the remaining linerless printing material 20 remains in the print start position I for too long, e.g., due to the linerless thermal printer 2 remaining inactive for a long time, the linerless printing material 20, in particular its front end 26, sticks to the platen roller 6.

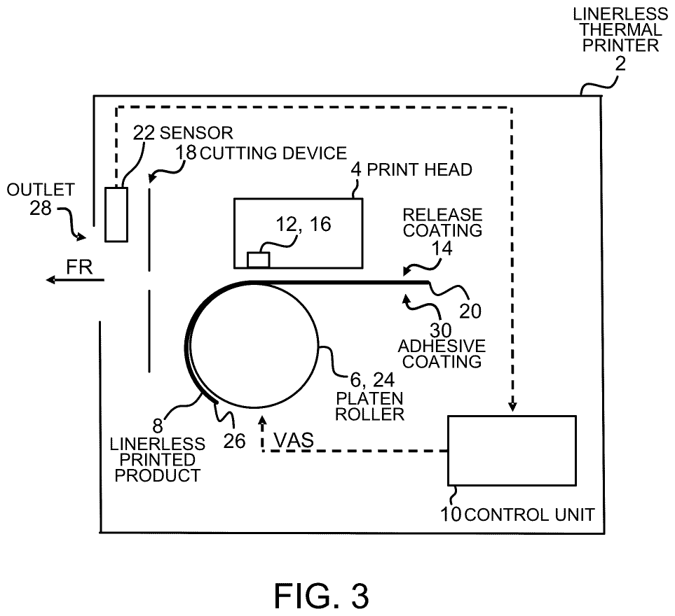

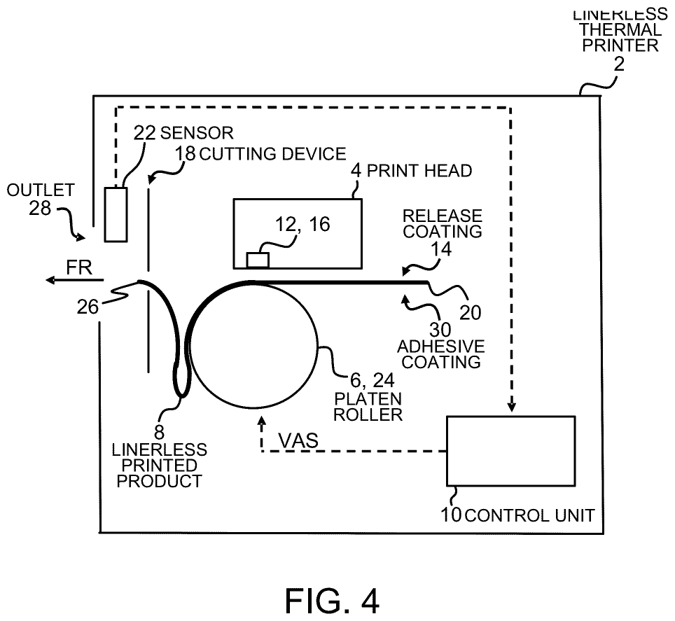

Additionally, reference is now made to FIGS. 3-4. If a new printing operation is initiated, the remaining linerless printing material 20 or the linerless printed product 8 can then wrap around the platen roller 6 (see FIG. 3).

If the remaining linerless printing material 20 or the linerless printed product 8 continues to be transported, a paper jam may form within the linerless thermal printer 2 between the cutting device 18 and the print head 4/platen roller 6 (see FIG. 4). Alternatively, a paper jam may form in front of the cutting device 18 (not shown).

Additionally, reference is now made to FIG. 5. In order to prevent such unwanted sticking of the linerless printing material 20 to the platen roller 6 and to facilitate easy release of any sticking between the linerless printing material 20 and the platen roller 6, after completion of a preceding printing operation, the linerless printing material 20 is first moved forward, as explained later (see steps S100 and S200). It is then moved in the reverse direction RR starting from the position in FIG. 5 by a predetermined feed length W1, until the front end 26 of the linerless printing material 20 reaches the position of the sensor 22 or a waiting position II, respectively (see FIG. 6). Thereby, it brings about a signal change in the measurement signal MS, e.g., from logical zero to logical one. In this case, the sensor 22 provides a changing measurement signal MS.

The feed length W1 can measure between 3 and 15 mm, preferably between 5 and 10 mm, more preferred about 5 mm. For this, in the present exemplary embodiment, the control unit 10 controls the motor 24 of the platen roller 6 with a reverse control signal RAS in such a way that the linerless printing material 20 is moved counter to the conveying direction FR, i.e., in the reverse direction RR.

In the present exemplary embodiment, the measurement signal MS is therefore a binary signal with, for example, logical one representing a detected front end 26 of the linerless printing material 20, while logical zero represents no detected front end 26 of the linerless printing material 20.

The front end 26 of the linerless printing material 20 is an edge that results from a completed linerless printed product 8 being separated from the linerless printing material 20 by the cutting device 18 of the linerless thermal printer 2. The front end 26 of the linerless printing material 20 is thus detected by the sensor 22, such as an optical sensor, such as a light barrier. Although the feed length W1 is predetermined, control of the transport by the sensor, ensures exact transport up to the sensor irrespectively of any potential disturbances. For example, this allows for the possibility that a user has pulled on the front end 26 such that the exact position of the front end 26 is unknown when starting the reverse transport.

Additionally, reference is now made to FIG. 6. The waiting position II is shown. The waiting position II, may be the position at which the front end 26 of the linerless printing material 20 that brings about the signal change. Alternatively and preferably, it may be a position beyond the sensor 22 (in conveying direction), such that the linerless printing material 20 is initially transported backwards to bring about the signal change.

After the front edge 26 of the linerless printing material 20 has been detected, the front end 26 of the linerless printing material 20 is now moved by a predetermined feed length W2. For this too, in the present exemplary embodiment, the control unit 10 controls the motor 24 of the platen roller 6 with the reverse control signal RAS in such a way that the linerless printing material 20 is moved counter to the conveying direction FR, i.e., in the reverse direction RR. In order to bring about the movement of the linerless printing material 20 by the predetermined feed length W2, a predetermined duty cycle of the motor 24 can be provided, or a predetermined number of revolutions and/or partial revolutions of the platen roller 6 are carried out. After being transported the feed length W2, the linerless printing material 20 is in the print start position I and printing can commence.

After printing is finished, the linerless printing material 20 including the printed product 8 is transported forward beyond the cutting device 18 and the printed product 8 is separated from the remaining linerless printing material 20 by cutting. Thereupon, the linerless printing material may be transported back to the print start position I (see FIG. 2). This can be considered as the terminus of a printing operation. Alternatively, the printing operation may terminate with the cutting off of the printed product.

In the present exemplary embodiment, provision is made, for a timer (not shown) of the control unit 10 to be started once the printing operation is terminated. After expiration of a predetermined time period T, a forward control signal VAS is provided to move the linerless printing material 20 beyond the sensor 22 (in conveying direction) (see FIG. 5). Subsequently, by the provision of a reverse control signal RAS, the linerless printing material 20 is moved backwards by a feed length W1.

The moving continues until the sensor 22 detects that the waiting position II has been reached. The control unit 10 then no longer provides the reverse control signal RAS and the motor 24 stops. In a next step, the reverse control signal RAS is provided to move the linerless printing material backwards by feed length W2 to the print start position.

According to a further exemplary embodiment, provision is made for a manual trigger signal to be detected, and upon detection of the manual trigger signal, the forward control signal VAS is provided for controlling the motor 24 of the linerless thermal printer 2 driving the platen roller 6 so as to move the linerless printing material 20 in the conveying direction FR. For this, in the present exemplary embodiment, the linerless thermal printer 2 has an actuation button (not shown) by means of which, when pressed, a user can generate the trigger signal for moving the linerless printing material 20. Instead of an actuation button, a touch button on a touch screen of the linerless thermal printer 2 or a corresponding menu item in the operating menu of the linerless thermal printer 2 can also be provided.

Provision can also be made for a user to be able to select between a manual operating mode by the above mentioned actuation button and an automatic operating mode. Such a selection can be made by the user pressing a corresponding switch. Instead of a switch designed as an additional actuation button, an additional touch button on a touch screen of the linerless thermal printer 2 or a corresponding additional menu item in the operating menu of the linerless thermal printer 2 can also be provided.

According to both embodiments, the front end 26 of the linerless printing material 20 does not remain in the print start position I (see FIG. 2) after completion of a printing operation, but is brought into the waiting position II (see FIG. 1) or a waiting position beyond the sensor 22 (in the conveying direction), in which the front end 26 of the linerless printing material 20 has a distance greater than zero in the conveying direction FR, from the print head 4 and the platen roller 6, respectively, the distance corresponding to the predetermined feed length W2.

The predetermined feed length W2 is dimensioned such that, after movement in the reverse direction RR, the front end 26 of the linerless printing material 20 is located in the print start position I between the print head 4 and the platen roller 6. In other words, the predetermined feed length W2 by which the linerless printing material 20 is moved corresponds to the distance between the print start position I and the waiting position II.

When starting a new printing operation, the front end 26 of the linerless printing material 20 is brought into the print start position I by moving the linerless printing material 20 in the reverse direction RR, thereby reliably preventing unintentional winding. While moving in the reverse direction RR, no printing is applied to the linerless printing material 20, i.e., the print head 4 is inactive.

To safeguard the system, in particular for preventing the linerless printing material 20 from unintentionally slipping backwards off the platen roller 6 during reverse transport, paper transportation is monitored by the sensor 22. The sensor 22 monitors the presence of the linerless printing paper 20, and in particular the front end 26 of the linerless printing paper 20. For example, if after a predetermined time period during forward transport, the sensor 22 does not detect the front end 26 of the linerless printing material 20, the movement is aborted. Likewise, if the sensor 22 does not detect the front end 26 of the linerless printing material 20 during the reverse transport, paper transport is aborted. In addition, no reverse transport will be initiated in these cases if a new printing process is started. In other words, if the sensor 22 fails to detect the front end 26 of the linerless printing material 20 as required, the next printing operation will start with the linerless printing material 20 in its current position. Finally, in a preferred embodiment, no transport of linerless printing material 20, in particular no reverse transport, will be initiated, if the sensor 22 fails to detect linerless printing material 20 to be present at all, e.g., after the printer is switched on.

In the above mentioned situations, the control unit 10 suppresses the provision of the reverse control signal RAS, when initiating a subsequent printing operation. In other words, the front end 26 of the linerless printing material 20 remains in its current position. By this means, the printer 2 can determine the presence, the position and the unobstructed transport of the linerless printing material 20.

Some specific examples of a procedure according to the invention are provided in the following:

Example 1 (using a timer, waiting position at the sensor):
printing is completed;
the linerless printing material 20 comprising the printed product 8 is transported forward beyond the cutting device 18;
the printed product 8 is cut from the linerless printing material 20 by the cutting device 18;
the linerless printing material 20 is transported backwards to the print start position I;
the timer starts;
when the timer has expired (e.g., after 30 minutes) without a new printing operation being started, the linerless printing material 20 is transported forward until detected by the sensor 22;
the linerless printing material 20 is transported forward by the feed length W1, e.g., measuring between 3 and 15 mm, preferably between 5 and 10 mm, more preferred about 5 mm;
the linerless printing material 20 is transported backwards until detected by sensor 22 (should correspond to feed length W1 but need not) and has reached waiting position II;
upon starting of a new printing operation, the linerless printing material 20 is transported backwards to print start position I;
printing commences.

Example 2 (using a timer, waiting position beyond the sensor):
printing is completed;
the linerless printing material 20 comprising the printed product 8 is transported forward beyond the cutting device 18;
the printed product 8 is cut from the linerless printing material 20 by the cutting device 18;
the linerless printing material 20 is transported backwards to the print start position I;
the timer starts;
when the timer has expired (e.g., after 30 minutes) without a new printing operation being started, the linerless printing material 20 is transported forward until detected by the sensor 22;
the linerless printing material 20 is transported forward by the feed length W1, e.g., measuring between 3 and 15 mm, preferably between 5 and 10 mm, more preferred about 5 mm;
upon starting of a new printing operation, the linerless printing material 20 is transported backwards until detected by sensor 22 (should correspond to feed length W1 but need not);
the linerless printing material 20 is transported backwards to print start position I;
printing commences.

Example 3 (no timer used, waiting position beyond the sensor):
printing is completed;
the linerless printing material 20 comprising the printed product 8 is transported forward beyond the cutting device 18;
the printed product 8 is cut from the linerless printing material 20 by the cutting device 18;
the linerless printing material 20 is transported forward to the sensor 22;
the linerless printing material 20 is transported forward by the feed length W1, e.g., measuring between 3 and 15 mm, preferably between 5 and 10 mm, more preferred about 5 mm;
upon starting of a new printing operation, the linerless printing material 20 is transported backwards until detected by sensor 22 (should correspond to feed length W1 but need not);
the linerless printing material 20 is transported backwards to print start position I;
printing commences.

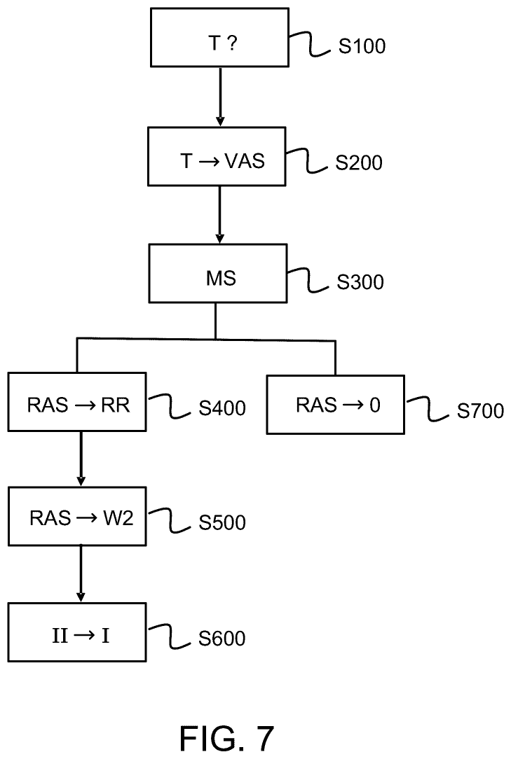

A method for operating the thermal printer 2 will now be explained with additional reference to FIG. 7.

According to a first exemplary embodiment, in a first step S100, upon completion of a preceding printing operation and after expiration of a predetermined time period T, the control unit 10 provides the forward control signal VAS in order to move the front end 26 of the linerless printing material 20 in the conveying direction FR. Depending on where the linerless printing material 20 is positioned when the time period T expires, the process may, for example, start with the linerless printing material 20 being at the print start position I.

The forward control signal VAS is provided by the control unit 10 for controlling the motor 24 (step 200) until the front end 26 of the linerless printing material 20 has reached the position shown in FIG. 5. For this, the front end 26 of the linerless printing material 20 is firstly transported forward until it is detected by the sensor 22 (step 300, explained below). If the front end 26 of the linerless printing material 20 has brought about a signal change in the sensor 22, the linerless printing material 20 is then moved further in the conveying direction FR beyond the sensor 22, for example by the predetermined feed length W1.

According to a further exemplary embodiment, the step 200 is initiated not by a timer (step 100) but by a manual trigger signal. According to this embodiment, in a further step S200, upon detection of the manual trigger signal, and similar to the preceding exemplary embodiment, the forward control signal VAS is provided by the control unit 10 for controlling the motor 24 until the front end 26 of the linerless printing material 20 has reached the position shown in FIG. 5.

Both embodiments of the method can comprise the following steps S300 to S700. In a further step S300, the control unit 10 reads the measurement signal MS from the sensor 22, which is indicative of reaching the position shown in FIG. 5. In a further step S400, the control unit 10 provides a reverse control signal RAS for controlling the motor 24 of the linerless thermal printer 2 driving the platen roller 6 so as to move the linerless printing material 20 in the reverse direction RR until the sensor 22 has detected the front end 26 of the linerless printing material 20. The print head 4 is inactive during this process, meaning no printing is carried out on the linerless printing material 20 during the reverse transport.

When the sensor 22 has detected the front end 26 of the linerless printing material 20, in a further step S500, the control unit 10 further provides the reverse control signal RAS in order to move the linerless printing material 20 in the reverse direction RR by the predetermined feed length W2. Here too, the print head 4 is inactive, meaning no printing is carried out on the linerless printing material 20. The control unit 10 provides the reverse control signal RAS for moving the linerless printing material 20 until the print start position I shown in FIG. 2 has been reached (step S600).

During this step, the print head 4 is again inactive, meaning no printing is carried out on the linerless printing material 20 during the reverse transport.

Step 600 may be carried out directly after the sensor 22 has detected the front end 26 of the linerless printing material 20 in step 400, e.g., if the linerless printing material 20 was positioned during a phase of inactivity at a position beyond the sensor (in the conveying direction) and was transferred therefrom to the sensor, e.g., upon the start of a new printing order.

Alternatively, the linerless printing material 20 may remain at the waiting position II during a phase of inactivity until a new printing process is initiated. In this case, the new printing process starts with step S600. In this way, the linerless printing material 20 and its adhesive layer 30, respectively, can be removed from the platen roller 6 reliably and with little effort.

If however the sensor 22 has not detected the front end 26 of the linerless printing material 20, either during forward transport (step S200) or during reverse transport (step S400), or no printing material is detected at all, the reverse control signal RAS is suppressed (step S700). Therefore, there is no moving to reach the print start position I, and the printing operation begins with the current position of the linerless printing material 20.

Individual steps can be skipped or omitted in deviation from the present exemplary embodiment.

### Reference Numerals

2 thermal printer
4 print head
6 platen roller
8 linerless printed product
10 control unit
12 heating line
14 release coating
16 heating element
18 cutting device
20 linerless printing material
22 sensor
24 motor
26 front end
28 outlet
30 adhesive layer
I print start position
II waiting position
FR conveying direction
MS measurement signal
RAS reverse control signal
RR reverse direction
T time period
VAS forward control signal
W1 predetermined feed length
W2 predetermined feed length
S100 step
S200 step
S300 step
S400 step
S500 step
S600 step
S700 step

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-12. (canceled)

13. A method for operating a linerless thermal printer, comprising:
moving a front edge of a linerless printing material in a reverse direction counter to a conveying direction from a waiting position towards a print start position, wherein the waiting position of the front edge is disposed on an opposite side of a cutter from a platen roller of the linerless thermal printer; and
printing on the linerless printing material after the moving of the front edge of the linerless printing material in the reverse direction, wherein the printing on the linerless printing material begins with the front edge of the linerless printing material being disposed at the print start position.

14. The method of claim 13, wherein the print start position of the front edge of the linerless printing material is disposed at the platen roller.

15. The method of claim 13, further comprising:
reading in a measurement signal from a sensor of the linerless thermal printer, wherein the measurement signal indicates whether the front edge of the linerless printing material has reached a position of the sensor;
generating a reverse control signal for controlling a motor of the linerless thermal printer that drives the platen roller so as to move the linerless printing material in the reverse direction until the sensor detects the front edge of the linerless printing material; and
generating the reverse control signal for controlling the motor of the linerless thermal printer that drives the platen roller so as to move the linerless printing material in the reverse direction by a predetermined feed length after the sensor has detected the front edge of the linerless printing material.

16. The method of claim 15, further comprising:
suppressing the reverse control signal for controlling the motor of the linerless thermal printer that drives the platen roller so as to move the linerless printing material in the reverse direction if after a predetermined time period of the moving in the reverse direction the sensor has not detected the front end of the linerless printing material.

17. The method of claim 15, further comprising:
upon detecting completion of a preceding printing operation, detecting expiration of a predetermined time period since the preceding printing operation; and
after expiration of the predetermined time period has been detected, generating a forward control signal for controlling the motor of the linerless thermal printer that drives the platen roller so as to move the linerless printing material in the conveying direction.

18. The method of claim 15, further comprising:
detecting a manual trigger signal; and
upon detecting the manual trigger signal, generating a forward control signal for controlling the motor of the linerless thermal printer that drives the platen roller so as to move the linerless printing material in the conveying direction.

19. A linerless thermal printer, comprising:
a print head;
a platen roller;
a cutter; and
a sensor, wherein the linerless thermal printer is configured to move a front edge of a linerless printing material in a reverse direction counter to a conveying direction from a waiting position to a print start position, wherein the waiting position of the front edge is disposed on an opposite side of the cutter from the platen roller, and wherein the linerless thermal printer moves the front edge of the linerless printing material in the reverse direction prior to printing on the linerless printing material.

20. The linerless thermal printer of claim 19, further comprising:
a motor that drives the platen roller; and
a controller configured to monitor a measurement signal output by the sensor, wherein the measurement signal indicates that the front edge of the linerless printing material has reached a position of the sensor, wherein the controller is configured to generate a reverse control signal for controlling the motor so as to move the linerless printing material in the reverse direction until the sensor detects the front edge of the linerless printing material, and wherein the controller is configured to generate the reverse control signal for controlling the motor so as to move the linerless printing material in the reverse direction by a predetermined feed length.

21. The linerless thermal printer of claim 20, wherein the linerless thermal printer is configured to suppress the reverse control signal if after a predetermined time period of moving the linerless printing material in the reverse direction the sensor has not detected the front end of the linerless printing material.

22. The linerless thermal printer of claim 20, wherein the linerless thermal printer is configured, upon detecting completion of a preceding printing operation, to detect expiration of a predetermined time period since the preceding printing operation and, after expiration of the predetermined time period has been detected, to generate a forward control signal for controlling the motor so as to move the linerless printing material in the conveying direction.

23. The linerless thermal printer of claim 20, wherein the linerless thermal printer is configured to detect a manual trigger signal and, upon detecting the manual trigger signal, to generate a forward control signal for controlling the motor so as to move the linerless printing material in the conveying direction.

24. The linerless thermal printer of claim 20, wherein the controller comprises a microcontroller.

25. A set of processor-executable instructions stored on a non transitory, processor-readable medium, wherein execution of the set of processor-executable instructions causes a central processing unit to perform operations including:
generating a reverse control signal for controlling a motor of a linerless thermal printer that drives a platen roller of the linerless thermal printer so as to move a front edge of a linerless printing material in a reverse direction counter to a conveying direction from a waiting position towards a print start position, wherein the waiting position of the front edge is disposed on an opposite side of a cutter of the linerless thermal printer from the platen roller;
detecting a measurement signal from a sensor of the linerless thermal printer, wherein the measurement signal indicates whether the front edge of the linerless printing material has reached a position of the sensor;
generating the reverse control signal for controlling the motor of the linerless thermal printer that drives the platen roller so as to move the linerless printing material in the reverse direction until the sensor detects the front edge of the linerless printing material;
generating the reverse control signal for controlling the motor of the linerless thermal printer that drives the platen roller so as to move the linerless printing material in the reverse direction by a predetermined feed length after the sensor has detected the front edge of the linerless printing material; and
printing on the linerless printing material after the moving of the front edge of the linerless printing material in the reverse direction, wherein the printing on the linerless printing material begins with the front edge of the linerless printing material being disposed at the print start position.

26. The set of processor-executable instructions of claim 25, wherein the print start position of the front edge of the linerless printing material is disposed at the platen roller.
